(19) United States
(12) Patent Application Publication
(10) Pub. No.: US 2019/0015178 A1
(43) Pub. Date: Jan. 17, 2019

(54) ARRANGEMENT HAVING A BRACKET AND A CLIP

(71) Applicant: DW Lingual Systems GmbH, Bad Essen (DE)

(72) Inventor: Dirk Wiechmann, Bad Essen (DE)

(21) Appl. No.: 16/021,656

(22) Filed: Jun. 28, 2018

(30) Foreign Application Priority Data
Jul. 11, 2017 (DE) 10 2017 211 867.9

(51) Int. Cl. A61C 7/30

(52) U.S. Cl. CPC A61C 7/30; A61C 7/143

(57) ABSTRACT

Arrangement includes a bracket having a pad and a bracket body having a slot for receiving an orthodontic wire, as well as, allocated to the bracket, a clip of a shape-memory material for closing and releasing of the slot of the bracket, for holding the orthodontic wire in a closing position in the slot, respectively to release it in an opening position for withdrawal from the slot. A first free end of the clip is a fixation end, which is rigidly connected to the bracket, and a second end of the clip is a free end which in the opening position lies against the bracket, releasing the slot, and in the closing position lies against the bracket, overlapping the slot.

### PRIORITY CLAIM

This application claims priority under 35 U.S.C. § 119 and all applicable statutes and treaties from prior German Application DE 10 2017 211 867.9, filed Jul. 11, 2017.

### FIELD OF THE INVENTION

The invention relates to an arrangement having a bracket and a clip. For the orthodontic treatment of patients using fixed braces, brackets are glued onto the teeth to be treated of the patient and are connected to one another by an orthodontic wire. The brackets have a pad for connection to the tooth and a bracket body having a slot, which receives the wire. In order to hold the wire in the slot a clip can be used which in an opening position releases the wire for withdrawal from the slot and in a closing position holds the wire in the slot.

### BACKGROUND

From U.S. Pat. No. 3,772,787 a clip is known which between the opening position and the closing position carries out a purely translational movement. From U.S. Pat. No. 5,562,444 a clip is known which between the opening position and the closing position carries out a purely rotational movement. Therein, U.S. Pat. No. 5,562,444 A shows a bracket having a clip which can be pivoted with one end over the slot and which is not rigidly connected to the bracket. U.S. Pat. No. 3,772,787 shows a bracket on which a U-shaped clip can be shoved over the slot in perpendicular to the slot and with one arm can engage into a recess opposite of the slot.

From U.S. Pat. No. 5,630,716 a clip is known which between the opening position and the closing position carries out a translational and a rotational movement.

U.S. Pat. No. 6,992,597 B2 shows a bracket on which the slot can be locked by a lid which is swiveably articulated at the bracket body. The lid is articulated in an articulation axis which runs parallel to the slot. The opposite end of the lid engages with the bracket body in order to be rigidly connected and having positive fit to the bracket body, and to firmly hold an archwire in the slot.

US 2017/0027666 A1 shows a U-shaped clip which as a whole is slidable over the slot, respectively over an orthodontic wire arranged therein, into a closing position and therein is guided with one arm in an occlusal-gingival slot. Therein, a stop nose on the guided arm can form a stop in an end position of the sliding. In the closing position the other arm with its end engages in undercuts which are formed at the bracket body so that in the closing position the arms of the clip between them embrace the archwire arranged in the slot.

U.S. Pat. No. 6,325,622 B1 describes a bracket on which a clamp is slidably guided in an occlusal-gingival slot and can be moved over the slot in order to hold therein an orthodontic wire.

US 2014/0199648 A1 describes a plate-shaped or U-shaped clip, one arm of which can be slid over the slot and the orthodontic wire and the opposite arm of which can be guided slidably between the bracket and the pad.

### SUMMARY OF THE INVENTION

The invention provides an arrangement having an alternative clip, respectively having an alternative bracket, which arrangement allows for a clean opening and closing of the clip also after a certain sojourn time in the mouth of a patient. A preferred embodiment provides a bracket having a pad and a bracket body having a slot for receiving an orthodontic wire, as well as a clip of shape-memory material allocated to the bracket for closing and releasing the slot of the bracket in order to hold in a closing position the orthodontic wire in the slot, respectively to release it in an opening position for removal from the slot, wherein a first end of the clip is a fixation end which is rigidly connected to the bracket, and a second end of clip is a free end, which in the opening position lies against the bracket while releasing the slot and in the closing position lies against the bracket overlapping the slot.

### DESCRIPTION OF THE DRAWINGS

Further features, details and advantages of the invention are evident from the claims and the following description of preferred embodiments as well as by way of the drawings. Therein show:

FIG. 1 a perspective elevation onto a material strip for producing a clip,

FIG. 2 a perspective cross-section of the material strip of FIG. 1,

FIG. 3 a clip in a perspective view,

FIG. 4 the clip of FIG. 3 in a further perspective view,

FIG. 5 a bracket body having a spacer section (this is known from DE 102011003894 A1) in a side view,

FIG. 6 the bracket body of FIG. 5 in a perspective view,

FIG. 7 the bracket body of FIG. 5 with a clip in closing position in a side view,

FIG. 8 the arrangement of FIG. 7 in a perspective view,

FIG. 9 the bracket body of FIG. 5 with the clip in opening position in a side view,

FIG. 10 the arrangement of FIG. 9 in a perspective view,

FIG. 11 an arrangement according to the invention having a bracket and a clip in a side view, and

FIG. 12 the arrangement of FIG. 11 in a perspective view.

### DETAILED DESCRIPTION

Generally, the bracket according to the invention can have a pad provided for fixation to a tooth surface, and having a bracket body connected to the pad, the bracket body having a slot for receiving an orthodontic wire, with a clip, the first end of which is rigidly connected to the bracket, especially to the bracket body, and the second end of which, which is spaced from the first end, is a free end, wherein the clip consists of shape-memory material and is adapted such that in a closing position its second end overlaps the slot in order to close the cross-section of the slot, and that in an opening position its second end is spaced from the slot in order to release the cross-section of the slot, so that e.g. an orthodontic wire in perpendicular to its longitudinal axis can be slid into the slot. The first end of the clip forms a fixation end that is stationary, respectively non-slidably fixed to the bracket, and preferably without an articulation bearing. Therein, the clip is moveable by bending between the closing position and the opening position, especially by bending in perpendicular to its longitudinal extension.

Also in an embodiment of the clip having a rectangular cross-sectional form, only the second end of the clip is moveable in relation to the bracket body, namely in perpendicular to the longitudinal axis of the slot, respectively in perpendicular to the longitudinal axis of an archwire which is to be arranged in the slot. Preferably, the slot is adapted to hold an orthodontic wire slidably along its longitudinal axis in the slot. Preferably, the slot has a cross-section, e.g. rectangular, of which a section, e.g. corresponding to its clear height or width is open. The open section of the cross-section of the slot in the closing position can be covered by the second end of the clip, and thereby the slot at its open side can in sections be covered by the free end.

Optionally, the clip is adapted to assume its closing position above a temperature of e.g. 20° C., 25° C. or 35° C., and it consists of a shape-memory material.

Generally preferred the free end of the clip in the closing position is arranged only against the cross-section of the slot, especially against the open side of the cross-section of the slot, respectively against an orthodontic wire arranged in the slot by the spring tension, respectively, restoring force that the clip itself exhibits. In the closing position, the free end does not engage with form-fit and/or non-positively to the bracket, respectively to the bracket body.

The arrangement of the free end of the clip against the cross-section of the slot, respectively against an orthodontic wire arranged in the slot results in a spring loading of the archwire into the slot, because the free end of the clip is not fixed to the bracket and is not held at the bracket by form fit, respectively does not engage in undercuts or recesses of the bracket. The free end can be arranged freely in a recess of the bracket, especially of the bracket body. In the closing position the free end can be arranged in a recess of the bracket, but without contact to the bracket. The spring load exerted by the free end of the clip onto the cross-section of the slot, respectively against an archwire arranged in the slot holds the orthodontic wire in the slot, wherein small friction forces between the orthodontic wire and the free end, respectively the slot, are generated, for example, preferably smaller friction forces are possible than those exerted by an arm of a clip in which both ends are held on the bracket in the closing position with form fit and/or non-positively.

The arrangement of the free end of the clip in closing position only against the cross-section of the slot, respectively against an orthodontic wire arranged in the slot and only by the spring tension of the clip itself has the advantage that no undercut or recess at the bracket engages the free end non-positively and/or with form fit, so that the arrangement of the free end in the closing position is not disturbed by deposits in an undercut or recess of the bracket.

A further advantage of the arrangement of the free end of the clip in closing position only against the cross-section of the slot, respectively against an orthodontic wire arranged in the slot by the spring tension, respectively, restoring force of the clip into the closing position is that the free end due to its spring tension, respectively, restoring force readily arranges itself into the closing position. Therein, following insertion of an orthodontic wire into the slot, it is not necessary that the free end would have to be moved into the closing position, e.g. it is not necessary to insert the free end of the clip by means of a tool into the closing position into a recess or undercut of the bracket. Therefore the arrangement, respectively the bracket according to the invention having the clip fixed at its fixation end, allows a simple opening of the slot by moving the free end into its opening position, e.g. by means of a tool, and, e.g. after arranging an orthodontic wire in the slot, a simple arrangement of the free end into the closing position, e.g. by the free end being moved away from a bearing surface, upon which it rests on in the opening position, because the free end moves itself into the closing position due to the restoring force of the clip itself.

The free end of the clip generally at least in the closing position is loaded only by its restoring force against the slot, respectively against an orthodontic wire arranged therein, and especially does not lock in place with the bracket.

Opposite of its opening the slot has a bottom face which is limited by two side faces. The side faces preferably are in perpendicular to the bottom face. Opposite of the bottom face, the side faces between them open up the opening of the slot, through which an orthodontic wire can be inserted into the slot. Preferably the orthodontic wire has a rectangular cross-section, of which two opposite faces are arranged matchingly or with a spacing against the side faces of the slot. Optionally, at least the side face of the slot which is arranged more closely to the free end of the clip has a reduced depth in perpendicular to the bottom face of the slot, than the cross-section of the orthodontic wire, so that the orthodontic wire at least with its surface, preferably with its edge that is closer to the free end of the clip, projects over the slot. Optionally, both side faces of the slot can have a smaller depth to its bottom face than the cross-section of the orthodontic wire extends along the side faces, so that the orthodontic wire projects over the side faces of the slot and over the opening of the slot. In these embodiments in the closing position the region of the clip bordering on the free end, or the free end, can directly lie on the orthodontic wire. Generally, the bracket can have a recess in which the free end of the clip is arranged in the closing position without contact to the bracket.

The arrangement comprises a bracket with a pad and a bracket body having a slot arranged therein for receiving an orthodontic wire as well as a clip of a shape-memory material coordinated to the bracket for closing and opening the slot of the bracket, wherein the clip is arranged to hold an orthodontic wire in the slot in a closing position, respectively to release it in the opening position for removal out of the slot, wherein a first end of the clip is a fixation end which is rigidly connected to the bracket, and a second end of the clip opposite the first end is a free end which is arranged to lie against the bracket opening the slot in the opening position, and to overlap the slot in the closing position. Therein the clip is moveable between the opening position and the closing position only by elastic bending and has a spring tension, respectively a restoring force, which in the closing position loads its free end against the open side of the cross-section of the slot, respectively against an orthodontic wire arranged in the slot.

Therein, the bracket can have a supporting face for the free end of the clip, on which supporting face the free end lies on in the opening position, e.g. with its abutting surface, and optionally a further supporting face, on which the free end lies in the absence of an orthodontic wire in the slot in the closing position.

Optionally the bracket can have a supporting face for the free end of the clip in its opening position and the bracket and the clip can be arranged such that in the closing position the free end is only loaded against the cross-section of the slot, without contacting the bracket, wherein especially upon arrangement of an orthodontic wire in the slot, in the closing position the free end is only loaded against the wire.

Advantageously, the bracket has at least one hook and/or at least one wing.

The bracket preferably consists of a cobalt-chrome-compound.

Advantageously, the bracket has a through-bearing for the clip in which a section of the clip is held that lies between the fixation end and the free end of the clip.

The through bearing for the clip preferably has a cross-sectional shape, especially a rectangular cross-sectional shape, which corresponds to that of the clip, but in each dimension is larger by at maximum 20%, preferably at maximum 10% larger and, further preferred, at maximum 5% larger.

Advantageously, the through-bearing for the clip is formed in the bracket body.

Preferably the bracket has a supporting face, one each for the free end of the clip in the opening position and one for the free end in the closing position, especially having a contour which is adapted to a contour of the free end, especially to the front face of the free end, in order to stably arrange the free end thereon.

Advantageously, the supporting faces are shaped as plane supporting faces. Optionally, the front face of the free end is parallel to the adjacent cross-section of the free end, preferably having rounded edges at its narrow sides.

According to the invention, the clip consists of a super-elastic shape-memory material, especially a NiTi-compound, and it is especially programmed into the closing position.

Preferably, the clip has an engagement opening, especially circle-shaped, for allowing the mechanical engagement of an orthodontic instrument, especially of a probe, for gripping the free end and moving it from the closing position into the opening position.

Advantageously, in its development the clip is a material strip which in elevation and in both side views essentially has a rectangular form, especially the material thickness of the material strip is in the range of from 0.05-0.5 mm, preferably 0.2 mm, and a breadth of the material strip is in the range of 1-6 mm, preferably 2 mm, and a length of the material strip is in the range of 1-10 mm, preferably 6 mm.

Preferably, the fixation end of the clip is connected to the bracket by means of a welded joint, especially a laser-welded joint, or by means of a glued joint or by a clamping joint especially by means of a ductile broadening.

Advantageously, the clip in sections has a reduction of the material strength, especially in the region of the through-bearing for the clip, further especially directly adjacent to this, especially a reduction by 30-70%, preferably by 40-60%, and further preferred by 50%.

Preferably, the material strength reduction has a low plateau, especially central and planar, from which in both axial directions the material strength reduction rises along a ramp each to the material thickness, wherein the material strength reduction in the elevation onto the region of the first leg of the clip specifically has the shape of a circle segment or of a square or of a rectangle or of a circle.

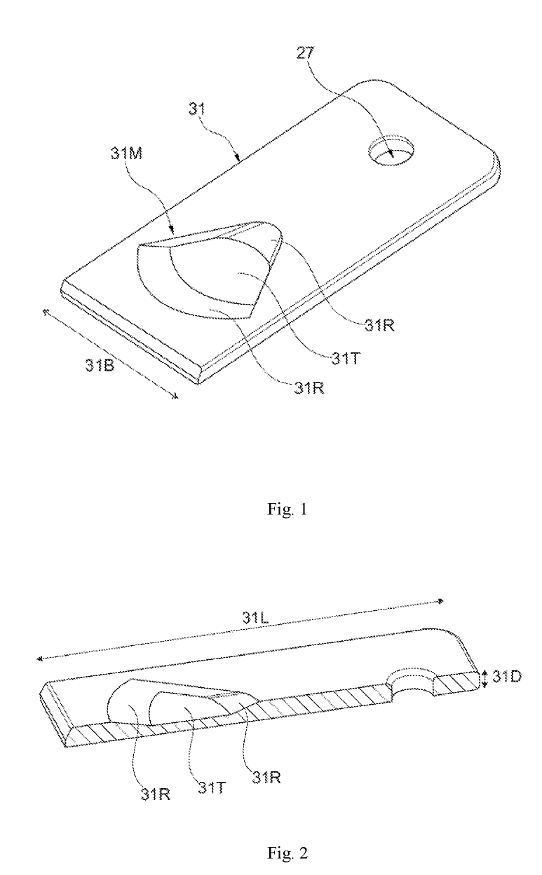

FIG. 1 shows a perspective view of a material strip 31 of a super-elastic NiTi-compound. The material strip has a length 31L of 6 mm, a width 31B of 2 mm and a material thickness 31D of 0.2 mm.

The material strip 31 in the elevation and in both the side views essentially has the shape of a rectangle, except for the roundings formed at the corners (in FIG. 1 on both the corners of the upper narrow sides), respectively the bevel (in FIG. 1 on the lower narrow side of the material strip 31).

Further, in the material strip 31, see also FIG. 2, there is provided an essentially circle segment-shaped material reduction 31M, presently produced by depth-erosion: in a central and planar deep plateau 31T of the material reduction 31M the material thickness 31D is reduced by 50%. Starting from the deep plateau 31T a ramp 31R each extends to the one and to the opposite narrow sides in the longitudinal direction of the material strip 31. At their ends lying opposite in longitudinal direction the ramps 31R each have the shape of a circle segment, as does also the deep plateau 31T. The respectively other opposite sides of the ramps 31R and of the deep plateau 31T are formed straight.

In the material strip 31 a circle-shaped engagement opening 27 is formed in order to generate an opportunity for engagement of a probe, as described further below.

For use with a bracket the material strip of FIGS. 1 and 2 is shaped into a suitable form in which between a middle section of a first leg having the material reduction an angle of 90° is formed, and of 85° between the middle section and a second leg with the engagement opening 27, wherein the second leg is shorter than the first leg.

The material strip 31 of the super-elastic NiTi-compound is programmed into this shape by heating.

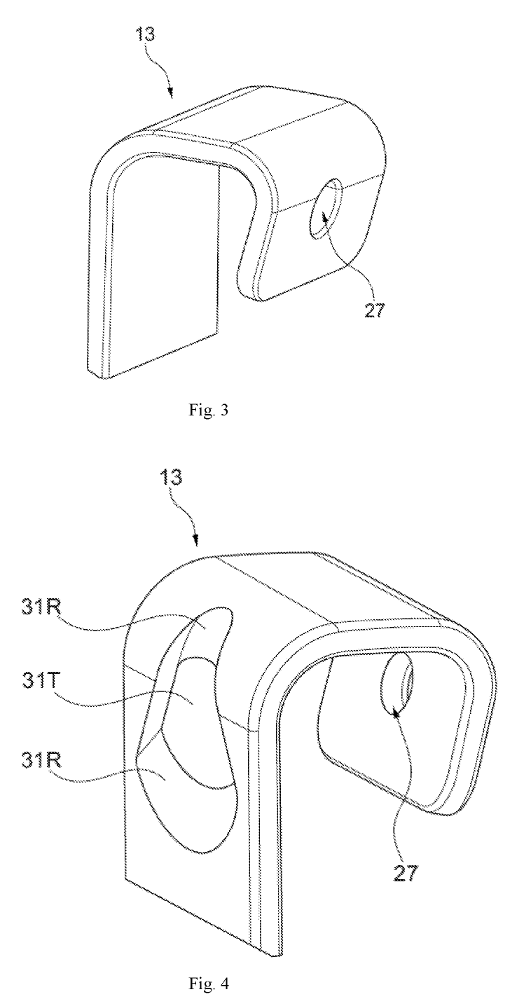

FIGS. 3 and 4 show perspective views of the clip 13 formed in this manner from the material strip 31.

As shown in FIG. 4, the material strength reduction 31M starts between the middle section and the first leg.

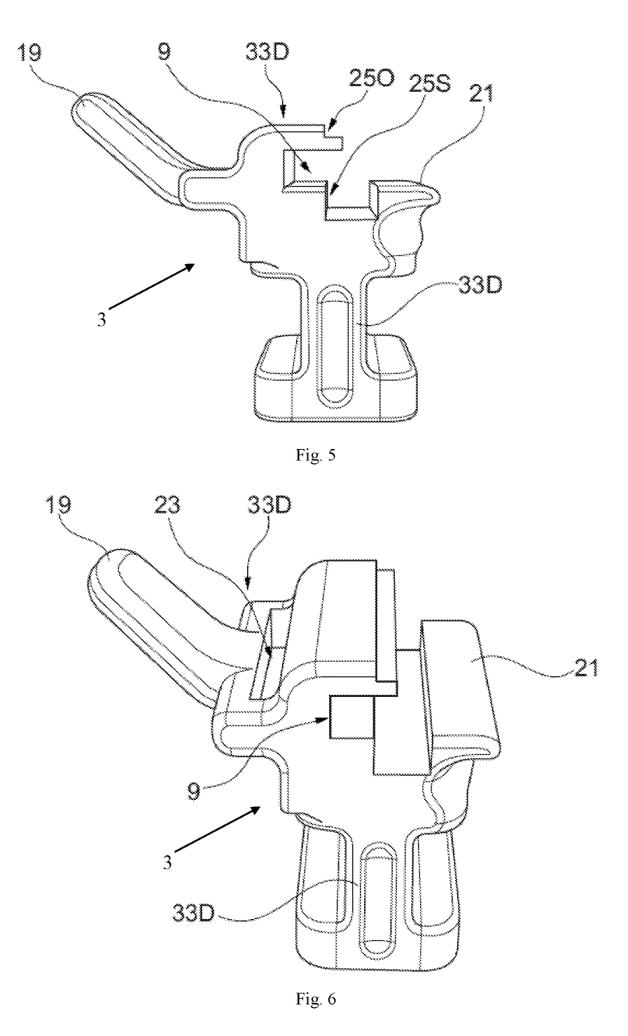

FIGS. 5 and 6 show a side view, respectively a perspective view of a raw bracket body 33 having a spacer section 33D as it is described in DE 102011003894 A1. A hook 19 and a wing 21 extend from a bracket body 7. The bracket body 8 has a slot 9 for receiving an orthodontic wire. A spacer section 33D joins the bracket body 7, which spacer section is cut through patient-specifically in order to fix a patient-specific pad thereon, as described in DE 102011003894 A1.

However, the raw bracket body 33 of FIGS. 5 and 6 has the following differences over the raw bracket body known from DE 102011003894 A1: between the bracket body 7 and the hook 19 there is provided a through-bearing 23 for the clip. Further, two supporting faces 25 are formed on the bracket body 7 in order to arrange thereon an end of the clip 13, as described below.

The through-bearing 23 for the clip is a slot-like opening in the bracket body 7, the opening cross-section of which in its form corresponds to the cross-section of the clip 13, presently a rectangular form. However, the through-bearing 23 for the clip in its measurements in each of the two independent dimensions of the rectangular form is slightly bigger than the clip 13 in order to receive this with a clearance as low as possible. Presently, the through-bearing 23 for the clip has e.g. a thickness of 0.3 mm (the clip 13 a thickness of 0.2 mm), and a width of 2.35 mm (the clip 13 a width of 2 mm).

The supporting faces 25 are two faces for stably arranging thereon the free end 17 in the closing position and in the opening position. The contours of the supporting faces 25 are accordingly adapted to the contour of the respective faces of the free end 17 that lie thereon: because the free end 17 is supported in each case with a face that is planar, both the supporting faces 25 are also planar faces. If alternatively a face of the free end were arcuate, the respective supporting face of the bracket were arcuate congruently thereto, in order to allow for a reception with form fit and therefore a stable support.

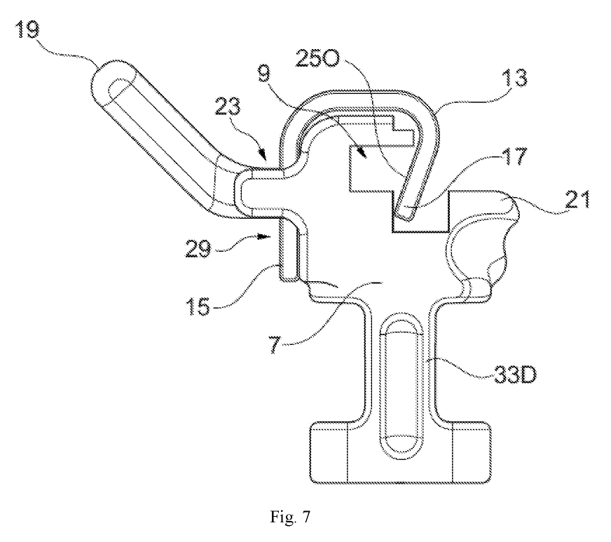

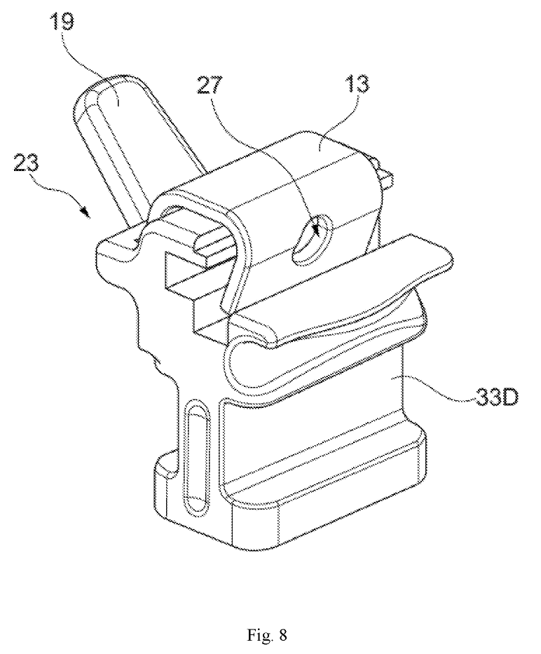

For producing the arrangement 1 according to the invention, the clip 13 of FIGS. 3 and 4 is slid onto bracket body 7 until reaching the position shown in FIGS. 7 and 8, wherein the first leg, i.e. the one having the material strength reduction 31M, is guided through the through-bearing 23 for the clip. As especially shown in FIG. 7, the clip 13 is slid onto the bracket body 7 up to the stop, i.e. the middle section of clip 13 lies the against bracket body 7. In FIG. 7, the material strength reduction 31M commences directly following the through-bearing 23 for the clip. In other words, the clip 13 runs through the through-bearing 23 for the clip up to the free end of the first leg of clip 13 without the material strength reduction 31M. In FIG. 7, the material strength reduction 31M commences directly subsequent to the through-bearing 23 for the clip. In this position the first leg of the clip 13 is locally strongly heated by a short laser pulse, dilates and deforms, optionally also by local melting, whereby this end plastically deforms and subsequently is rigidly connected to the bracket body while forming a clamping joint 29, whereby this end of the clip 13 forms a fixation end 15. Opposite this end the end of clip 13 forms a free end 17 and—overlapping slot 9—lies against a supporting face 25S for the free end.

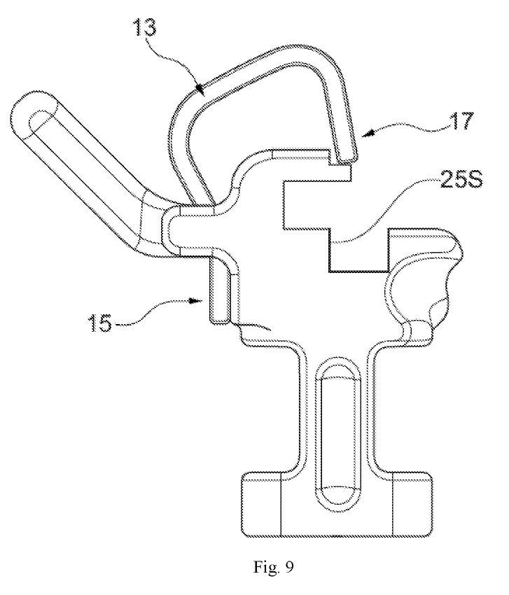

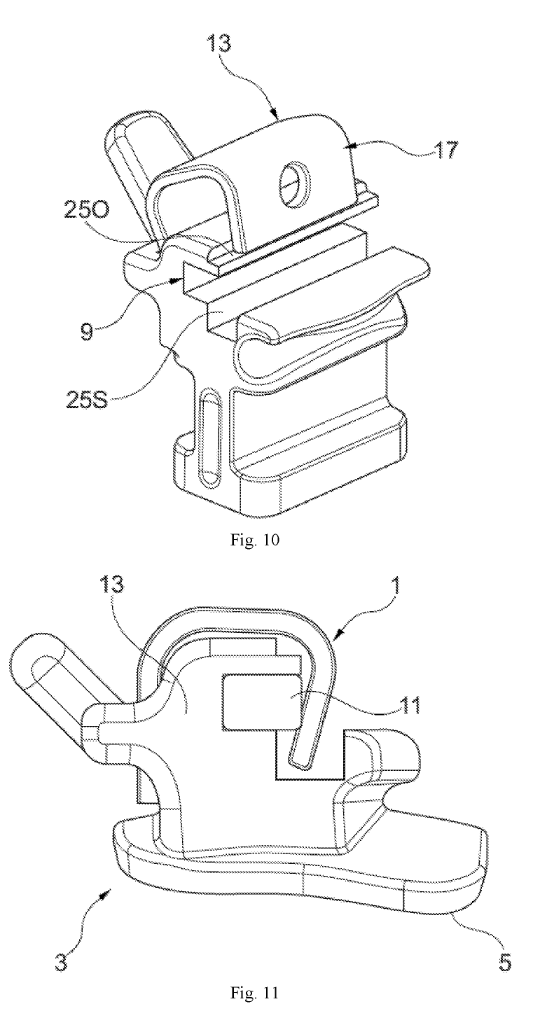

The supporting face 25S is a planar surface that runs in an angle of 90° to a side wall of slot 9. In order to move clip 13 from the closing position that is shown in FIGS. 7 and 8 into an opening position which is shown in FIGS. 9 and 10, in which an orthodontic wire can be inserted into slot 9 or can be removed therefrom, one can proceed as follows: the tip of a probe is introduced into the engagement opening 27 and then the probe is pulled until the free end 17 lies on a supporting face 25O. The supporting face 25O is a surface running in parallel to a side wall of slot 9, as especially shown in FIG. 9. Because the supporting face of the free end 17 runs in parallel to the supporting face 25, the free end 17 in the opening position lies stably on supporting face 25.

Upon opening clip 13 the first leg of clip 13 is bent in the level of the material strength reduction 31M around a side edge facing the hook 19 of the through-bearing 23 for the clip, as especially shown in FIG. 9. In other words, upon opening, the bending of clip 13 almost exclusively occurs in the first leg of clip 13, because this lies against the side edge of the through-bearing 23 for the clip. The angles between the middle section of clip 13 and the first leg, as well as between the middle section of clip 13 and the second leg therefore remain essentially unchanged.

By way of the shape and the extent of the material strength reduction 31M one can adjust the force that is necessary for bending the first leg of clip 13 in this point of the material strength reduction 31M. Therefore, the material strength reduction 31M is arranged in the first leg of clip 13, whereby at this location the clip 13 can more easily be deformed, respectively, be bent. This bending movement presently is supported by the material strength reduction 31M being arranged ahead of the through-bearing 23 for the clip, so that in the opening movement an edge of the through-bearing 23 for the clip forms a bending edge for the first leg of clip 13. When the material strength reduction 31 is large area and is a big reduction (e.g. 80%) then the first leg is easily being bent. If however the material strength reduction is small area and is small reduction (e.g. 10%), then the first leg can be bent with greater difficulty.

In order to transform the free end 17 of clip 13 back into the closing position, a probe can again be brought into engagement with the engagement opening 27. Alternatively, clip 13 can be pushed by hand into the closing position, e.g. using a finger, or using a ligature handle utilized in the mouth of a patient. Because clip 13 is programmed into the closing position shown in FIGS. 7 and 8, it warms in the mouth of a patient and by itself assumes the programmed closing position in which the free end 17 stably lies on supporting face 25S or, as shown in FIG. 11, on the orthodontic wire 11.

As described in DE 102011003894 A1, for producing a bracket 3 preferably subsequently the spacer section 33D is cut through patient-specifically, and a pad 5 is fixed to the bracket body 7, preferably by means of laser welding. By this step, a bracket 3 results from raw bracket body 33.

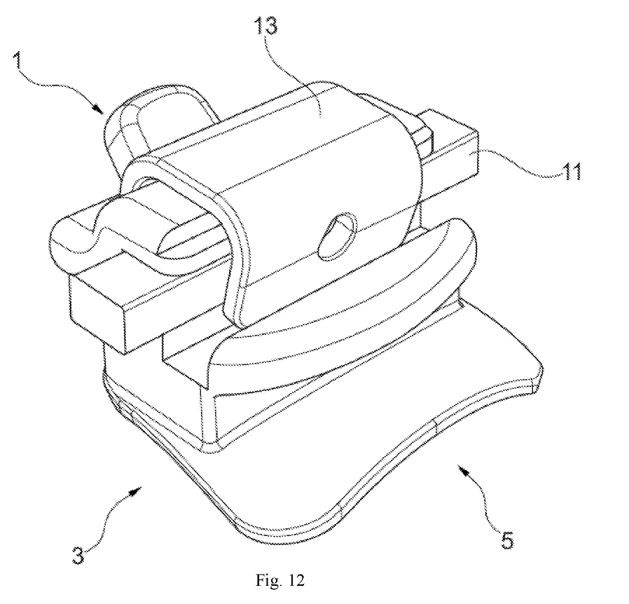

FIGS. 11 and 12 show the arrangement 1 according to the invention of a bracket 3, in which the fixation end 15 of clip 13 is rigidly connected. The free end 17 of clip 13 holds an orthodontic wire 11 in the slot 9 of bracket 3.

When bracket 3 is glued onto a tooth of a patient, tartar can deposit on bracket 3 and on clip 13. On the one hand by the specific shape of clip 13, which except for the second leg, which overlaps slot 9, allover lies against bracket 3, only little tartar can deposit between clip 13 and bracket 3, and on the other hand by the strong bending of clip 13 at the through-bearing 23 for the clip upon opening and closing of clip 13, deposited tartar is cracked off due to occurring shear, the arrangement 1 according to the invention results in significantly less problems by tartar upon opening and closing of the clip 13.

The free end 17 therefore in the opening position, respectively in the closing position can respectively be arranged stably on the supporting face 25O, 25S, so that the fixation end 15 of clip 13 is to be provided and to be fixed on the side of the bracket body 7 opposite of the free end 17.

The wing 21 is provided on the bracket in order to hold the orthodontic wire 11 on the bracket 3 by means of a conventional ligature, when the clip 13 is not available, respectively, when it is broken or not on stock.

The bracket 3 can be a lingual bracket or a buccal bracket.

The material strength reduction 31M can be arranged on both sides of clip 13, i.e. on the outside of clip 13, as is shown in FIG. 3, or on the opposite side, i.e. on the inside of clip 13 of FIG. 4.

Advantageously, the first leg of clip 13 is rigidly connected to the bracket body 7 with clamping by means of a plastic broadening. In the above-mentioned embodiment this occurs by a short laser pulse, which results in a plastic broadening (mushrooming) of the first leg, and thereby to a clamping connection 29 to the bracket body 7. Other variations for a plastic broadening are conceivable: the first leg of clip 13 could also be expanded mechanically in order to achieve a clamping joint, e.g. by strong pressing or light strokes onto the first leg of clip 13, for example using a rigid probe, a small screwdriver and a hammer, etc.

### LIST OF REFERENCE SIGNS

1 arrangement
3 bracket
5 pad
7 bracket body
9 slot
11 orthodontic wire
13 clip
15 fixation end
17 free end
19 hook
21 wing
23 through-bearing for the clip
25O supporting face for the free end in opening position
25S supporting face for the free end in closing position
27 circle-shaped engagement opening
29 clamping joint
31 material strip
31B width of the material strip
31D material thickness
31L length of the material strip
31M material strength reduction
31T deep plateau
31R ramp
33 raw bracket body
33D spacer section of the raw bracket body

1. Arrangement comprising a bracket having a pad and a bracket body having a slot for receiving an orthodontic wire, as well as a clip of shape-memory material allocated to the bracket for closing and releasing the slot of the bracket in order to hold in a closing position the orthodontic wire in the slot, respectively to release it in an opening position for removal from the slot, wherein a first end of the clip is a fixation end which is rigidly connected to the bracket, and a second end of clip is a free end, which in the opening position lies against the bracket while releasing the slot and in the closing position lies against the bracket overlapping the slot.

2. Arrangement according to claim 1, wherein the bracket has at least one hook and/or at least one wing.

3. Arrangement according to claim 1, wherein the bracket consists of a cobalt-chrome-compound.

4. Arrangement according to claim 1, wherein the bracket has a through-bearing for the clip in which a section of the clip is held that lies between the fixation end and the free end.

5. Arrangement according to claim 4, wherein the through-bearing for the clip has a cross-sectional shape that corresponds to that of the clip, but is larger in each dimension by at maximum between 5-20%.

6. Arrangement according to claim 1, wherein the through-bearing for the clip is formed in the bracket body.

7. Arrangement according to claim 1, wherein the bracket has a supporting face for the free end each in the opening position and in the closing position for the free end of the clip, and a contour which is adapted to a contour of the free end for stably arranging the free end thereon.

8. Arrangement according to claim 7, wherein the supporting faces are formed as planar supporting faces.

9. Arrangement according to claim 1, wherein the bracket has a supporting face for the free end of the clip in its opening position, and in the closing position the free end is loaded against the cross-section of the slot only without contacting the bracket.

10. Arrangement according to claim 1, wherein the clip consists of a super-elastic shape-memory material and is programmed into the closing position.

11. Arrangement according to claim 1, wherein the clip has an engagement opening for allowing a mechanical engagement of an orthodontic instrument for gripping and moving the free end from the closing position into the opening position.

12. Arrangement according to claim 1, wherein the clip in its development is a material strip which in an elevation and in both side views essentially has a rectangular form, and the material strip lies in the range of 0.05-0.5 mm, and a width of the material strip lies in the range of 1-6 mm, and a length of the material strip lies in the range of 1-10 mm.

13. Arrangement according to claim 1, wherein an orthodontic wire is arranged in the slot.

14. Arrangement according to claim 1, wherein the fixation end of the clip is connected to the bracket by a welded joint or a glued joint or a clamping joint.

15. Arrangement according to claim 1, wherein the clip in sections has a material strength reduction in a range of 30-70%.

16. Arrangement according to claim 15, wherein the material strength reduction comprises central and planar deep plateau, from which in both axial directions the material strength reduction each along a ramp increases to the material thickness, wherein the material strength reduction in an elevation onto the area of the first leg of the clip has the form of a circle segment or of a square or of a rectangle or of a circle.

17. Arrangement according to claim 1, wherein the slot has side walls which between them delimit a bottom face of the slot and opposite thereto open up an opening of the slot, wherein at least that side wall which in the closing position is to be arranged closer to the free end extends above the bottom face to a smaller extent than the cross-section of the orthodontic wire to be arranged in the slot.
